(19) United States
(12) Patent Application Publication
(10) Pub. No.: US 2009/0057241 A1
(43) Pub. Date: Mar. 5, 2009

(54) FILTER ASSEMBLY

(76) Inventor: Phillip Nauta, Stouffville (CA)

Correspondence Address: BERESKIN AND PARR, 40 KING STREET WEST, BOX 401, TORONTO, ON, M5H 3Y2, CA

(21) Appl. No.: 11/960,018

(22) Filed: Dec. 19, 2007

Related U.S. Application Data
(60) Provisional application No. 61/007,899, filed on Aug. 29, 2007.

(51) Int. Cl. C02F 1/00; B01D 35/30

(52) U.S. Cl. 210/767; 210/232; 210/282

(57) ABSTRACT

A filter assembly for a household water filtration apparatus, and a method for filtering water using a household water filtration apparatus are provided. The filter assembly comprises a through-flow cartridge, which has an accessible cavity. The cartridge is removably received in the household water filtration apparatus. The filter assembly further comprises a water permeable enclosure that contains filter media, which is removably received in the accessible cavity. The method comprises opening a through-flow cartridge, depositing a filter packet in the cartridge, closing the cartridge, depositing the cartridge in the household water filtration apparatus, and passing water through the cartridge.

### CROSS-REFERENCES TO RELATED APPLICATIONS

This application claims priority from U.S. patent application Ser. No. 11/846,949 (filed on Aug. 29, 2007), which is incorporated herein by reference in its entirety.

### FIELD OF THE INVENTION

The invention relates to filter assemblies for a portable water filtration apparatus. More specifically, the invention relates to filter assemblies that are openable to permit filter media, such as activated carbon, to be replaced in household countertop portable water filtration apparatus.

### BACKGROUND OF THE INVENTION

Portable water filtration apparatus, such as those sold under the Brita trade mark, include countertop water filters and faucet mounted water filters. These water filters typically include a filter assembly that includes a filtration media, such as activated carbon. These filter assemblies are filted into the water filters. For example, a filter assembly may be fitted onto or into a funnel member coupled to a receiving container (a water reservoir) for collecting liquid, or onto a fixture coupled to a faucet wherein the water from the faucet flows through the fixture prior to being dispensed.

Known filter assemblies generally include a cartridge which houses granulated carbon. For example, U.S. Pat. No. 6,012,232 to Weyrauch and U.S. Pat. No. 6,099,728 to Bairischer describe a cartridge in the form of a closed cup, which has holes on the upper and lower portions through which water passes as it is filtered. The cup houses granulated carbon, and the holes on the upper and lower portions are covered with a sieve cloth to prevent the granulated carbon from escaping. Over time, the granulated carbon in such cartridges becomes spent, and the user must dispose of the cartridge and replace it with a new one.

### SUMMARY OF THE INVENTION

In one broad aspect, the present invention provides a filter assembly for a portable water filtration apparatus. The filter assembly comprises a through-flow cartridge, wherein the cartridge has an accessible cavity. A water permeable enclosure is removably received in the accessible cavity. The cavity may be openable (such as by the cartridge having a moveable or removable lid) or the cartridge may be provided with an access slot though which a cartridge may be inserted. The permeable enclosure houses a filtration media. Preferably, the filter assembly is removably received in the water filtration apparatus. However, in an alternate embodiment, the cavity may be opened while the filter assembly is positioned in the water filtration apparatus.

In another broad aspect, the present invention provides a method for filtering water using a water filter apparatus. The method comprises opening a through-flow cartridge, depositing a filter packet in the cartridge, closing the cartridge, depositing the cartridge in the portable water filtration apparatus, and passing water through the cartridge.

An advantage of the present invention is that as the filtration media becomes spent, the permeable enclosure may be removed from the cartridge and replaced, without requiring the replacement of the entire cartridge. The cartridge is typically comprised of plastic. Plastic is not biodegradable and will remain in landfill for an extended period of time. By replacing the filter media and reusing the cartridge, the amount of waste that is sent to landfills is reduced. Further, much or substantially all of the waste that is sent to land fill, namely the filter media, may be biodegradable.

A further advantage of the present invention is that the space required to store replacement permeable enclosures is less then the space required to store replacement cartridges. The components of a replacement cartridges are relatively inexpensive. However, the volume occupied by them has a substantial impact on the cost of shipping and warehousing the product. Accordingly, by providing replacement permeable enclosures, costs and storage space may be reduced.

In accordance with one aspect of the present invention, there is provided a filter assembly for a household water filtration apparatus, the filter assembly comprising:
(a) a through-flow cartridge having an accessible cavity, wherein the cartridge is received in the household water filtration apparatus;
(b) a water-permeable enclosure removably receivable in the accessible cavity, and,
(c) the permeable enclosure housing filtration media.

In some embodiments, the through-flow cartridge is removably received in the household water filtration apparatus. In other embodiments, a portion of the through-flow cartridge is permanently secured to the household water filtration apparatus.

In some embodiments, the through flow cartridge is positioned in a gravity fed water flow passage from a feed water reservoir to a filtered water reservoir of the household water filtration apparatus.

In one embodiment, the through-flow cartridge comprises a cup having an openable lid. Preferably, the cup and the lid have mating screw threads. However, they may be moveably connected to each other by any means so as to permit access to the cavity. In some embodiments, the openable lid is accessible when a lid of the household water filtration apparatus is opened.

In another embodiment, the permeable enclosure comprises a mesh. Preferably, the mesh is non-woven. The mesh may comprise hydrophobic filaments. The mesh may be a plastic and, preferably, comprises at least one of polypropylene and nylon.

In another embodiment, the permeable enclosure has a longitudinally extending sidewall, a water permeable top, and a water permeable bottom. Preferably, the longitudinally extending sidewall is impermeable to water and the water permeable top and a water permeable bottom comprise a mesh.

In another embodiment, the permeable enclosure is without a fixed shape.

In another embodiment, the through-flow cartridge comprises a lower portion having apertures and an upper portion having apertures and the filter assembly further comprises at least one support structure that positions the permeable enclosure within the cavity and spaced from at least the lower apertures. Preferably, the at least one support structure retains the permeable enclosure spaced from the apertures of the lower portion and the upper portion. Accordingly, there may be an upper and a lower support structure.

In another embodiment, the at least one support structure is removable from the cartridge. Alternately, they may be formed as part of the cartridge.

In another embodiment, the support structures comprise an open web disc.

In another embodiment, the filtration media comprises at least one member selected from the group carbon, mineral stone and ceramic. The filter material may be any of those known in the art for gravity fed water filters.

In another embodiment, the household water filtration apparatus further comprises a filtered water reservoir that is less than 5 L in volume.

In another embodiment, the household water filtration apparatus comprises a container that is fabricated from glass.

Preferably, the water filtration apparatus is a portable water filtration apparatus and, more preferably, a countertop water filtration apparatus.

In accordance with another aspect of the present invention, there is provided a method for filtering water using a household water filtration apparatus, the method comprising:
(a) opening a through-flow cartridge;
(b) depositing a filter packet in the cartridge;
(c) closing the cartridge;
(d) depositing the cartridge in the household water filtration apparatus; and,
(e) passing water through the cartridge.

In one embodiment, the method further comprises removing the filter packet from the cartridge, and depositing another filter packet in the cartridge.

In another embodiment, the method further comprises placing a first support structure in the cartridge, below the filter packet.

In another embodiment, the through-flow cartridge comprises a lower portion having apertures, and the method further comprising retaining the filter packet spaced from the apertures of the lower portion. Preferably, the method further comprises placing another support structure in the cartridge, above the filter packet. In such an embodiment, the through-flow cartridge comprises an upper portion having apertures, and the method further comprises retaining the filter packet spaced from the apertures of the upper portion.

In another embodiment, the household water filtration apparatus is portable and the method further comprises transporting the household water filtration apparatus to a faucet to add water to a feed water reservoir.

In another embodiment, the method further comprises providing a water filtration apparatus with a filtered water reservoir having a volume of less than 5 L.

In another embodiment, the method further comprises opening a lid of the water filtration apparatus and subsequently opening a lid of the through-flow cartridge. For example, the through-flow cartridge may be removed from the water filtration apparatus prior to opening the lid of the through-flow cartridge. Alternately, the lid of the through-flow cartridge may be opened while the through-flow cartridge is positioned in the water filtration apparatus.

In another embodiment, the method further comprises simultaneously opening a lid of the water filtration apparatus and opening a lid of the through-flow cartridge.

### BRIEF DESCRIPTION OF THE DRAWINGS

These and other advantages of the present invention will be more fully and particularly understood in connection with the following description of the preferred embodiments of the invention in which:

FIG. 1 is a front elevation view of a portable water treatment apparatus including a filter assembly as is known in the art;

FIG. 2 is a perspective drawing of an embodiment of a filter assembly of the present invention;

FIG. 3 is an exploded view of the filter assembly of FIG. 2;

FIG. 4 is a partial longitudinal cross-section along the line 4-4 of the embodiment of FIG. 2;

FIG. 5 is an enlarged cross-section of area A of FIG. 4;

FIG. 6 is an enlarged cross-section of area B of FIG. 4;

FIG. 7 is a partial longitudinal cross-section along line 4-4 of the embodiment of FIG. 2, shown together with a portable water treatment apparatus; and

FIG. 8 is a partial longitudinal cross-section along line 4-4 of an alternate embodiment of FIG. 2 wherein a portion of the cartridge is secured to the water treatment apparatus, shown together with a portable water treatment apparatus, with a lid of a cartridge opened, and with a permeable enclosure partially removed from the cartridge.

### DETAILED DESCRIPTION OF THE INVENTION

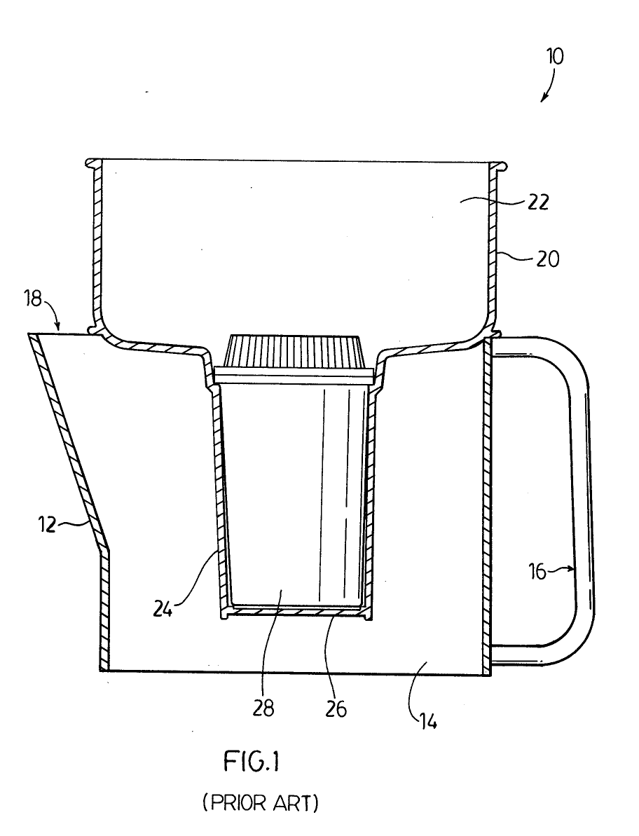

As shown in FIG. 1, a household water treatment apparatus 10 comprises a container 12 having a filtered water reservoir 14, an optional handle 16 and an optional pour spout 18. The volume of filtered water reservoir may be 0.5-5 liters, and preferably less than 2 litres. Accordingly, household water treatment apparatus 10 may be easily carried by a user by means of handle 16 and accordingly is typically used in household environments. In such an embodiment, household water treatment apparatus 10 comprises a portable water treatment apparatus. Such a portable water treatment apparatus 10 may be stored on a counter top in a kitchen or in a refrigerator. Portable water treatment apparatus 10 is also provided with an upper portion that defines a feed water reservoir 22. The feed water reservoir may be filed with water that is to be treated by being passed, due to gravity, through filter assembly 28. Filter assembly 28 is removably receivable in household water treatment apparatus 10, such as by being slideable receivable in filter assembly holder 24. Filter assembly holder has an open or porous bottom 26 through which filtered water passes into filtered water reservoir 14.

It will be appreciated that household water treatment apparatus 10 may be of any design known in the art. Further, household water treatment apparatus 10 may be mounted to a faucet, such as in a kitchen, and not require a feed water reservoir 22. In such an embodiment, household water treatment apparatus 10 may be secured to the outlet of a faucet, such as by a screw thread, and filtered water provided when the valve to the faucet is turned on. The filter cartridge of this invention may be used with any such household water treatment apparatus 10 and, is preferably used with a counter top water filtration apparatus as exemplified in FIG. 1.

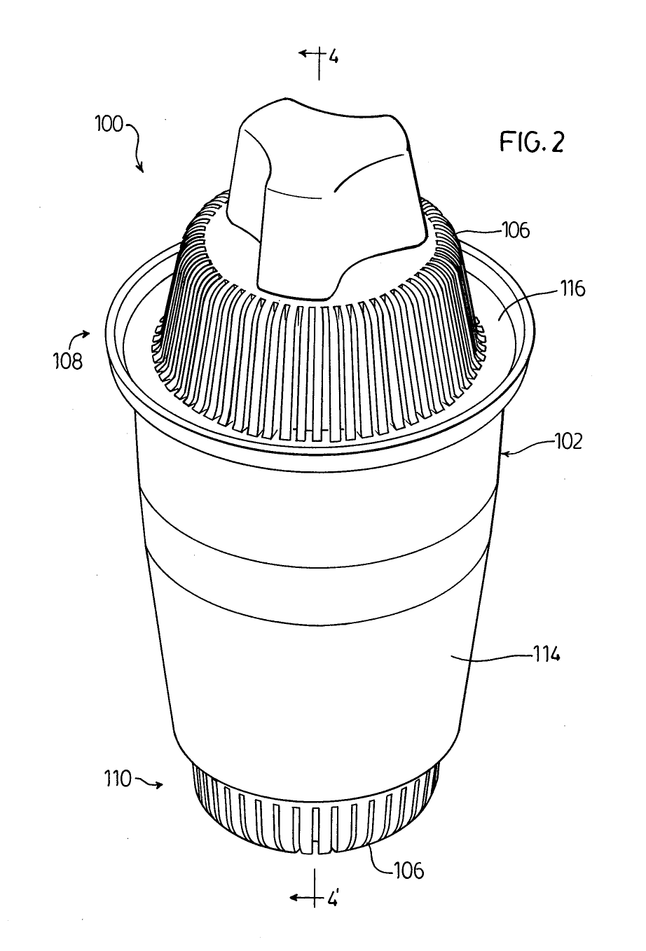

Referring to FIG. 2, an embodiment of a filter assembly 100 of the present invention is shown. Filter assembly 100 may be sized to be received in or secured to any household water filtration apparatus 10, such as the one exemplified in FIG. 1.

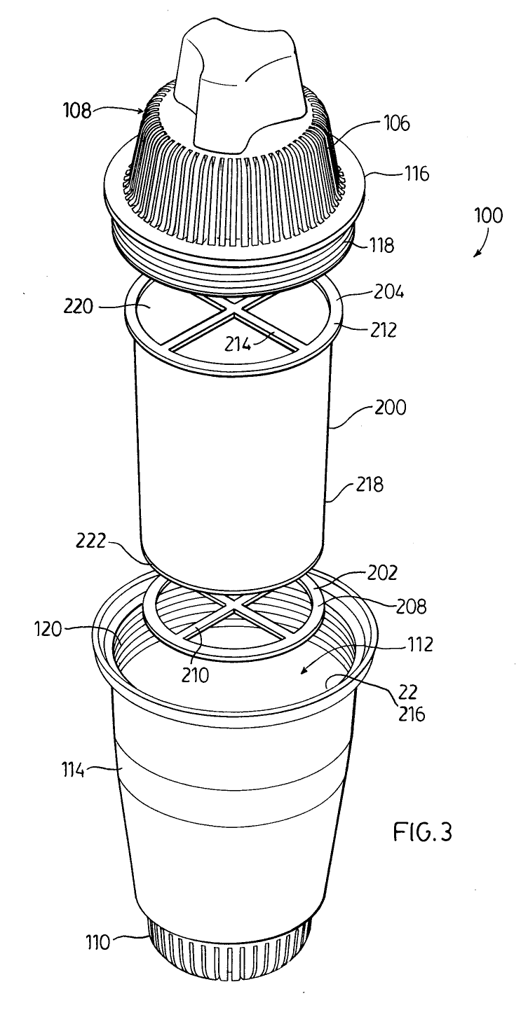

Referring to FIGS. 2 and 3, filter assembly 100 comprises a cartridge 102, and an enclosure or filter packet 200. Cartridge 102 is a through-flow cartridge. In the embodiments shown, through-flow is achieved via a plurality of apertures 106 in top portion 108 and in bottom portion 110 of cartridge 102. In other embodiments, however, through-flow may be achieved in other ways. For example, one or both of top and bottom portions 108, 110 may have a porous wall and/or they may be generally open. In particular, as filter media is retained by permeable enclosure 200, top and bottom portions 108, 110 need not be designed to retain filtration media within cartridge 102 (e.g., by having openings smaller than most of the particulate material of the filter media).

Cartridge 102 has an accessible cavity 112. That is, a user may access cavity 112 in order to insert and remove an enclosure 200 into cavity 112. For example, cartridge 102 may have one part that is removable from the rest of cartridge 102, or moveable with respect to the rest of cartridge 102, to provide an opening through which an enclosure 200 may be replaced.

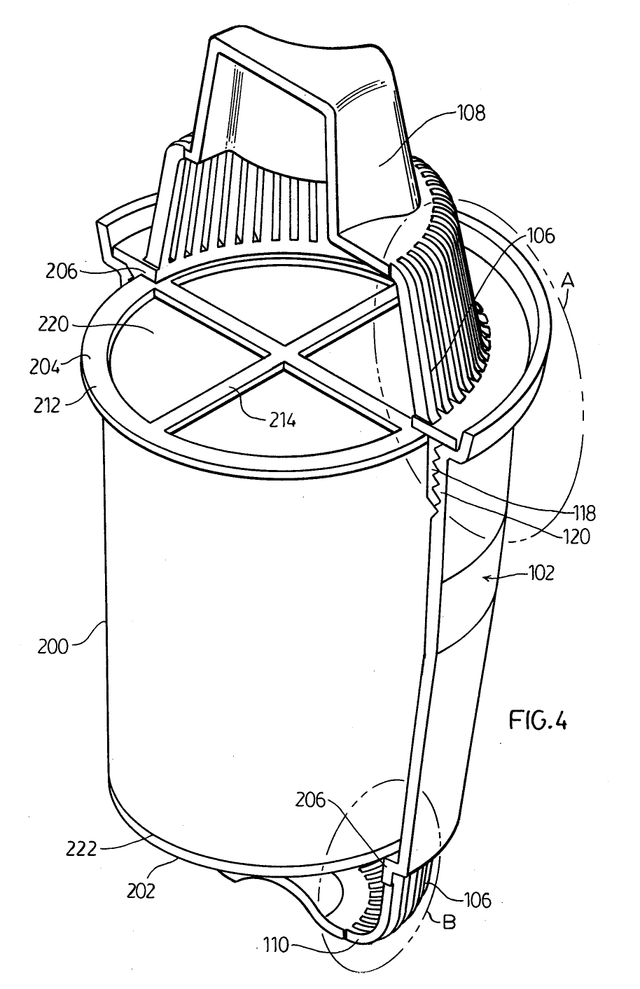

As exemplified in FIGS. 2-4, cartridge 102 comprises a cup 114 and a lid 116. As used herein, the term ‘cup’ refers to any structure that is sized to fit into a household water treatment apparatus and, accordingly, is typically longitudinally extending and has a base portion and at least one side wall. The term ‘lid’ refers to any structure that may either partially or fully fit on the top portion of a cup. It will be appreciated that in other embodiments, lid 116 may be non-removably secured to cup 114 and bottom portion 110 may be removable. Alternately, or in addition, cup 114 may be dividable into two portions, such as by one portion, e.g., a top half, pivoting or being removable from another portion, e.g., a lower half.

Accordingly, lid 116 may be either removable from or moveable relative to cup 114, in order to provide access to cavity 112. For example, cup 114 and lid 116 may have mating screw threads 118, 120, which may be screwed together or unscrewed by a user to obtain access to cavity 112. In other embodiments, cup 114 and lid 116 may mate via a snap-fit, a bayonet fit, external latch or the like. Alternately, lid 116 may be pivotally mounted to cup 114. Once disassembled, one or both of cup 114 and lid 116 may be washed, such as by placing them in a dishwasher. In other embodiments, cup 114 and lid 116 may mate by other means. Alternately, lid 116 may be pivotally mounted to cup 114 (not shown). An advantage of such an embodiment is that lid 116 may not be misplaced by a user.

In another embodiment, cartridge 102 may not comprise a cup and a lid, and may be any other through-flow structure which can be removably received in or secured to a portable water filtration apparatus, and which has an accessible cavity for removably receiving enclosure 200. For example, cartridge 102 may comprise a container, for example a hollow cylinder, having a permanently open slot or opening that provides access to cavity 112.

Enclosure 200 is removably receivable in cavity 112. That is, a user may insert enclosure 200 into and remove enclosure 200 from cavity 112. Enclosure 200 is water permeable, and houses or contains a filtration media. Enclosure 200 may be of any size that is receivable in cavity 112.

Enclosure 200 may be fabricated from a mesh, which may be either woven, or non-woven, and is preferably non-woven. Preferably, the mesh may be formed from hydrophobic filaments, for example polypropylene and/or nylon. It will be appreciated that the use of hydrophobic material is useful for preventing or minimizing degradation of enclosure 200 by absorption of water. In alternate embodiments, the mesh may be fabricated from other plastics or natural fibres, such as silk.

Enclosure 200 may be sufficiently rigid to retain a fixed shape. In such embodiments, enclosure 200 may be cylindrical, for example, as shown in FIGS. 2 and 3. In other embodiments, enclosure 200 may be deformable, soft-sided, or without a fixed shape. For example, enclosure 200 may have the same flexibility as a tea bag and, accordingly, need not have a fixed shape.

Enclosure 200 houses or contains one or more filter media. The filtration media may be any substance used in the household water filter art. In some particular embodiments, the filtration media may be granulated carbon. In embodiments wherein the filtration media is particulate, which is preferred, the pores or openings of the mesh are sized such that most, and preferably all or essentially all of the particles are retained in enclosure 200. For example, the particulate filtration media may be 5 mm in diameter, such as for coarse granular carbon to 0.25 mm, such as for very fine granular carbon, and the pores of the mesh may be 0.5 mm×0.5 mm (for a large mesh) to 0.01 mm×0.01 mm (for a very fine mesh) and, preferably, about 0.02 mm×0.02 mm.

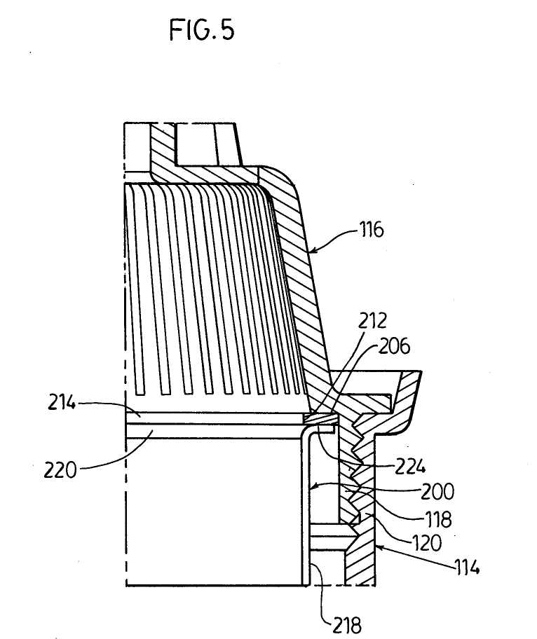

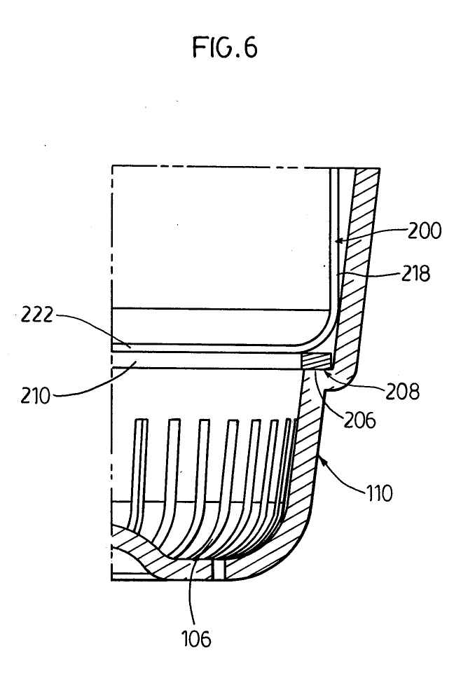

Preferably, enclosure 200 in retained in a position that is spaced from apertures 106, such that enclosure 200 does not clog, obstruct, or block apertures 106. In such embodiments, filter assembly 100 may comprise at least one support structure. For example, as shown in FIGS. 3-6, lower support structure 202 may be a disc with an open web structure. The disc comprises an outer ring 208 and a plurality of radial arms 210. The disc provides a support structure on which enclosure 200 may be received, and retained in a spaced relationship from apertures 106 of bottom portion 110. In other embodiments, support structure 202 may be, for example, a plate having apertures a ring, a cross, a bar, or any other structure that retains enclosure 200 in a position that is spaced apart from apertures 106.

In some embodiments, lower support structure 202 may be placed inside cavity 112 prior to depositing enclosure 200, in order to space enclosure 200 from apertures 106 in bottom portion 110. For example, support structure may be integrally formed with bottom portion 110 or it may be separately molded and removably or non-removably inserted in cartridge 102. Accordingly, if lower support structure 202 is not formed as part of cup 114, cup 114 is provided with a member to position lower support member 202 above apertures 106 and/or lower support member 202 is provided with members (e.g., feet) to position lower support member 202 above apertures 106. Thus, lower support member 202 may be retained by a friction fit with inner surface 216 of cup 114 or a lip 206 may be provided on which lower support structure 202 may be seated.

Alternately, or in addition, upper support structure 204 may be placed in cavity 112 after depositing enclosure 200, in order to retain enclosure 200 spaced from apertures 106 in top portion 110. Upper support structure 204 may be the same or different from lower support structure 202. Preferably, upper support structure 204 comprises a disc comprising an outer ring 212 and a plurality of radial arms 214. If upper support structure 204 is not formed as part of cup 114, cup 114 and/or lid 116 are provided with a member to position upper support structure 204 below apertures 106 and/or upper support structure 204 is provided with members (e.g., feet) to position upper support structure 204 below apertures 106. Thus, upper support structure 204 may be retained by a friction fit between outer ring 212 and inner surface 216 of cup 114 or a lip 206 may be provided on which lower support structure 202 may be seated. In other embodiments, support structures 202, 204 may be integral with enclosure 200.

In the exemplified embodiment, it is preferred that enclosure 200 comprises a longitudinally extending body having a rigid sidewall 218, a water permeable top 220 and a water permeable bottom 222. Sidewall 218 has a outer radial band 224 that has a diameter so as to be positioned beneath sidewall 218. Sidewall 218 has a longitudinal extent such that when enclosure 200 is seated on lower support member 202, band 224 seats upper support structure 204 against lip 206. Thus enclosure 200 is secured in position in a spaced relationship to apertures 106 of lid 116 and lower portion 110. It will also be appreciated that if sidewall 218 is not water permeable, then water cannot bypass the filtration media in enclosure 200 but must pass through the filtration media. In other embodiments, a radial band 224 may not be provided and enclosure 200 may be positioned in cavity 112 between lower support member 202 and upper member 204. As noted previously, in an alternate embodiment, enclosure 200 may be deformable, soft-sided, or without a fixed shape and accordingly, in such an embodiment sidewalls 218 made of a mesh material may be provided.

As previously mentioned, in the above-described embodiments, filter assembly 100 may be removably receivable in a household water filtration apparatus. For example, in some embodiments, filter assembly 100 may be removed from a household water filtration apparatus by sliding cartridge 102 from a filter assembly holder, such as filter assembly holder 24. Alternatively, filter assembly 100 may be removably receivable in household water filtration apparatus in another suitable manner. In any such embodiment, filter assembly 100 is positioned in the fluid flow path to the filtered water reservoir 14. Preferably, it is positioned between a feed water reservoir 22 and a filtered water reservoir 14.

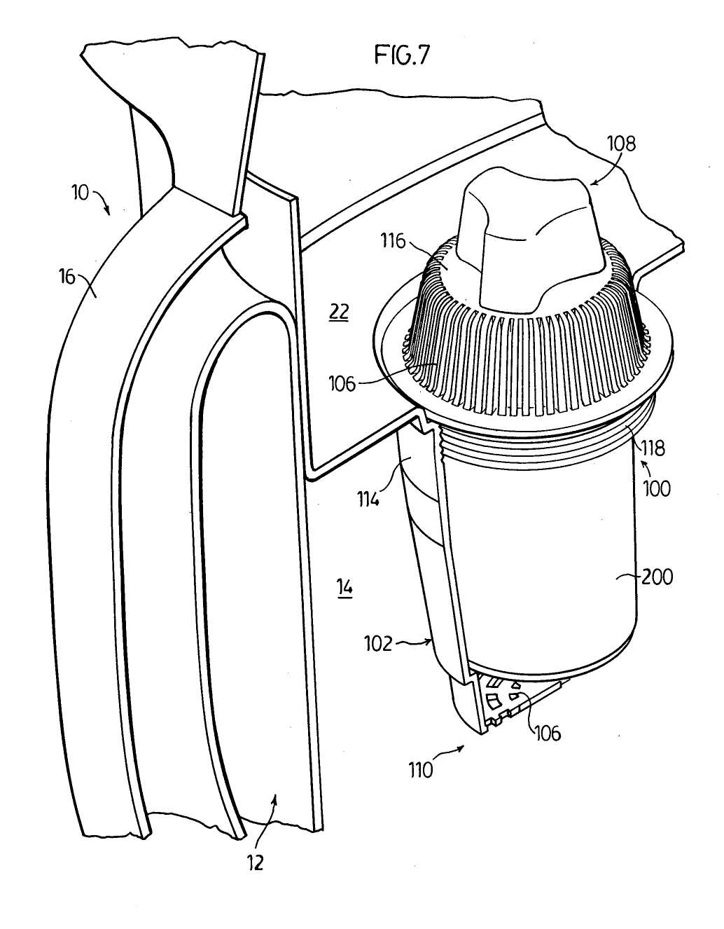

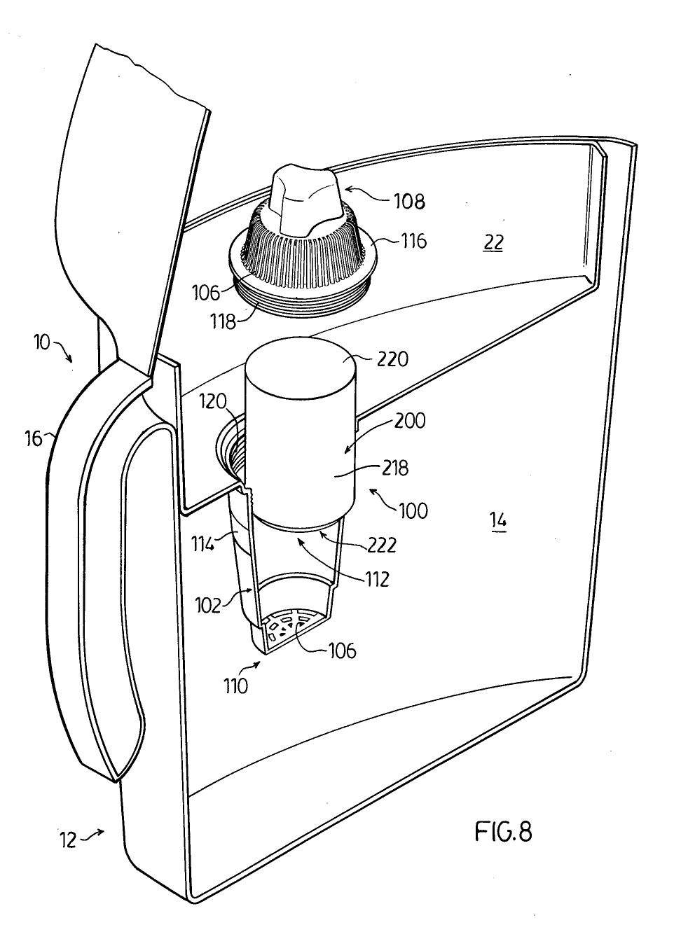

In alternate embodiments, as shown in FIGS. 7 and 8, at least a portion of filter assembly 100 may be permanently secured to container 12. As used herein, the term ‘permanently secured’ indicates that during normal use, a user may not remove the portion of filter assembly 100 from container 12. In such an embodiment, filter assembly holder 24 may not be required. As shown in FIGS. 7 and 8, this may be accomplished by permanently securing at least a portion of cartridge 102 to household water filtration apparatus 10. For example, in embodiments wherein cartridge 102 comprises a cup 114 and a lid 116, cup 114 may be integrally formed with a part household water filtration apparatus 10, or may subsequently be secured thereto by mechanical attachment members such as a screw thread, a latch or the like, or by an adhesive or welding or the like.

In such embodiments, lid 116 is movable from the top of cup 114 while cup 114 is in position in water filtration apparatus 10, such that permeable enclosure 200 may be removed from cartridge 102, as shown in FIG. 8. Lid 116 may be removably mounted thereto or moveably mounted thereto by any method disclosed herein. If the water filtration apparatus has a feed water reservoir 22 with a lid 30, then it will be appreciated that lid 116 may be removed after lid 30 of feed water reservoir 22 is opened. Alternately, lid 116 may be openable when lid 30 is opened, such as if an arm extends from lid 30 to lid 116. In such a case, lid 116 may be secured in position by such an arm and/or a snap fit.

A method of filtering water using a portable water filter apparatus will now be described. The method may be carried out using filter assembly 100, as exemplified in FIGS. 2-6, or may be carried out with another filter assembly as described herein. In a first step, a user may obtain a flow-through cartridge, for example cartridge 102 described hereinabove. The through flow cartridge may be permanently secured to the portable water filtration apparatus, or may be removably received therein. The user may then open the cartridge, if it is not acquired in an open condition, for example by unscrewing a lid. A filter member, for example a filter packet comprising enclosure 200 housing filtration media, may then be placed inside the cartridge. When the filter member has been placed inside the cartridge, the user may then close the cartridge.

The user may wish to ensure that the filter member is retained in a position that is spaced apart from any apertures in either or both of the top and bottom portions of the cartridge. Thus, in one embodiment, prior to and/or after placing the filter member in the cartridge, the user may place one or more support structures in the cartridge. Alternatively, as described hereinabove, the cartridge may be formed with integral support structures, and thus the user may not need to position any support structures.

In alternate embodiments, the cartridge may be structured such that the cavity may be accessed without a step of opening or closing. For example, as mentioned hereinabove, the cartridge may comprise a slot or opening that remains open. In such an embodiment, the user may insert the enclosure into the cartridge, without opening or closing the cartridge.

If the cartridge is removably received in the portable water filtration apparatus, the cartridge may be deposited into a portable water filtration apparatus either before or after the filter member has been placed in the cartridge. In alternate embodiments, the cartridge may be permanently secured in the water filtration apparatus and the filter member replaced while the cartridge is in position. Such an apparatus may be a jug or other container, for example, having a funnel or holder 24 in which the cartridge is to be placed (see for example FIG. 1), or having the cartridge permanently secured thereto. Alternatively, such an apparatus may be a fitting for a water faucet, having an encasement in which the cartridge will be housed. In other embodiments, the portable water filtration apparatus may be another type of household or countertop water filtration apparatus.

When the cartridge has been placed in the household water filtration apparatus and the filter member has been replaced, or when the permanently secured cartridge has been closed with a replacement filter member therein, water may be passed through the cartridge, preferably by gravity feed. This may be done, for example, by pouring water over the cartridge (e.g., filling a feed water reservoir above the cartridge), or by turning on a faucet if the cartridge is provided in the flow line.

As the water filtration apparatus is used, the filtration media may become spent. For example, with typical household use, the filtration media may become spent after a period of about 2-4 months. When this occurs, the user may replace the filter member with another filter member. In order to replace the filter member, the user may optionally remove the cartridge from the household water filtration apparatus, open the cartridge, remove the filter member (enclosure 200), deposit another filter member into the cartridge, close the cartridge, and optionally return the cartridge to the water filtration apparatus. Alternately, the user may open the cartridge while the cartridge is in position in the water filtration apparatus and then replace the filter member.

Thus, embodiments of the present invention provide a water filter assembly and a method for filtering water that allows for cost effective, and less wasteful replacement of spent filtration media. Embodiments of the present invention may be advantageous because as the filtration media becomes spent, the permeable enclosure may be removed from the cartridge and replaced, without requiring the replacement of the entire cartridge.

It will be appreciated that certain features of the invention, which are, for clarity, described in the context of separate embodiments or separate aspects, may also be provided in combination in a single embodiment. Conversely, various features of the invention, which are, for brevity, described in the context of a single embodiment or aspect, may also be provided separately or in any suitable sub-combination.

Although the invention has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present invention.

We claim:

1. A filter assembly for a household water filtration apparatus, the filter assembly comprising:
(a) a through-flow cartridge having an accessible cavity, wherein the cartridge is received in the household water filtration apparatus; and,
(b) a water-permeable enclosure removably receivable in the accessible cavity; and
(c) the permeable enclosure housing filtration media.

2. The filter assembly of claim 1, wherein the through-flow cartridge is removably received in the cavity.

3. The filter assembly of claim 1, wherein a first portion of the through-flowcartridge is permanently secured to the household water filtration apparatus and a second portion that is removably mounted to the first portion.

4. The filter assembly of claim 1, wherein the first portion of the through flow cartridge is positioned between a gravity fed passage from a feed water reservoir to a filtered water reservoir of the household water filtration apparatus.

5. The filter assembly of claim 1, wherein the through-flow cartridge comprises a cup having an openable lid.

6. The household water filtration apparatus of claim 5, wherein the openable lid is accessible when a lid of the household water filtration apparatus is opened.

7. The filter assembly of claim 1, wherein the permeable enclosure comprises a mesh.

8. The filter assembly of claim 51 wherein the mesh is non-woven.

9. The filter assembly of claim 5, wherein the mesh comprises hydrophobic filaments.

10. The filter assembly of claim 1, wherein the permeable enclosure has a longitudinally extending sidewall, a water permeable top and a water permeable bottom.

11. The filter assembly of claim 10, wherein the longitudinally extending sidewall is impermeable to water and the water permeable top and a water permeable bottom comprise a mesh.

12. The filter assembly of claim 1, wherein the permeable enclosure is without a fixed shape.

13. The filter assembly of claim 1, wherein the through-flow cartridge comprises a lower portion having apertures and an upper portion having apertures and the filter assembly further comprises at least one support structure that positions the permeable enclosure within the cavity and spaced from at least the lower apertures.

14. The filter assembly of claim 13, wherein the at least one support structure retains the permeable enclosure spaced from the apertures of the lower portion and the upper portion.

15. The filter assembly of claim 13, wherein the at least one support structure is removable from the cartridge.

16. The filter assembly of claim 1, wherein the household water filtration apparatus comprises a filtered water reservoir that is less than 5L in volume.

17. The household water filtration apparatus of claim 1, wherein the household water filtration apparatus comprises a container that is fabricated from glass.

18. A method for filtering water using a household water filtration apparatus, the method comprising:
(a) opening a through-flow cartridge;
(b) depositing a filter packet in the cartridge;
(c) closing the cartridge;
(d) depositing the cartridge in the household water filtration apparatus; and,
(e) passing water through the cartridge.

19. The method of claim 18, further comprising removing the filter packet from the cartridge, and depositing another filter packet in the cartridge.

20. The method of claim 18, further comprising placing a first support structure in the cartridge, below the filter packet.

21. The method of claim 18, wherein the through-flow cartridge comprises a lower portion having apertures, and the method further comprises retaining the filter packet spaced from the apertures of the lower portion.

22. The method of claim 20, further comprising placing another support structure in the cartridge, above the filter packet.

23. The method of claim 18, wherein the through-flow cartridge comprises an upper portion having apertures, and the method further comprises retaining the filter packet spaced from the apertures of the upper portion.

24. The method of claim 18, wherein the household water filtration apparatus is portable and the method further comprises transporting the household water filtration apparatus to a faucet to add water to a feed water reservoir.

25. The method of claim 18, further comprising providing a water filtration apparatus with a filtered water reservoir having a volume of less than 5 L.

26. The method of claim 18, further comprising opening a lid of the water filtration apparatus and subsequently opening a lid of the through-flow cartridge.

27. The method of claim 26, further comprising removing the through-flow cartridge from the water filtration apparatus prior to opening the lid of the through-flow cartridge.

28. The method of claim 26, further comprising opening the lid of the through-flow cartridge while the through-flow cartridge is positioned in the water filtration apparatus.

29. The method of claim 18, further comprising simultaneously opening a lid of the water filtration apparatus and opening a lid of the through-flow cartridge.
